(19) United States
(12) Patent Application Publication
(10) Pub. No.: US 2014/0131484 A1
(43) Pub. Date: May 15, 2014

(54) NOZZLE FOR SPRAYING DRY ICE, NOTABLY DRY ICE MADE WITH CARBON DIOXIDE

(71) Applicants: Philippe Gomez, Tremblay-En-France (FR); Marc Leturmy, Gressey (FR); Benoit Loiselet, Bois D'Arcy (FR)

(72) Inventors: Philippe Gomez, Tremblay-En-France (FR); Marc Leturmy, Gressey (FR); Benoit Loiselet, Bois D'Arcy (FR)

(73) Assignee: L'Air Liquide Societe Anonyme pour L'Etude et L'Exploitation des Procedes Georges Claude, Paris (FR)

(21) Appl. No.: 14/128,632

(22) PCT Filed: Jun. 19, 2012
(86) PCT No.: PCT/FR2012/051375

§ 371 Date: Dec. 23, 2013

(30) Foreign Application Priority Data
Jun. 29, 2011 (FR) 1155802

(51) Int. Cl. B05B 1/02

(52) U.S. Cl. CPC B05B 1/02
USPC 239/597; 239/589

(57) ABSTRACT

The invention relates to a device for spraying particles of dry ice, notably for the purpose of cleaning surfaces, comprising a spray nozzle (4), allowing the passage of a working fluid carrying said particles, said nozzle (4) having an outlet orifice (5) and comprising a throat (6) and a divergent part (7) said divergent part (7) extending between the throat (6) and the outlet orifice (5) of the nozzle. According to the invention, said divergent part (7) has at least one first stage extending between the throat (6) and an outlet orifice of said first stage (5, 12) and the ratio between the area of the throat (6) and the area of said outlet orifice (5, 12) of the first stage of the divergent part is greater than 0.2.

### CROSS REFERENCE TO RELATED APPLICATIONS

This application is a 371 of International PCT Application PCT/FR2012/051375, filed Jun. 19, 2012, which claims priority to French Application No. 1155802, filed Jun. 29, 2011, the entire contents of which are incorporated herein by reference.

### BACKGROUND

The present invention relates to a device for spraying dry ice, notably dry ice made from carbon dioxide.

It will be particularly applicable in the field of cleaning surfaces, notably large surfaces such as vehicle body parts. However, this example is not limiting and the invention will also be applicable, notably, for cleaning smaller parts.

Cleaning by spraying dry ice made from carbon dioxide is effective due to the combination of various effects, a mechanical effect due to the kinetic energy of the ice particles, a thermal effect due to the temperature of the particles and a blast effect due to the sublimation of the ice in contact with the surface to be cleaned. Furthermore, it offers the advantage of not leaving any residue. Indeed, after sublimation, carbon dioxide ice, converted into gas, is evacuated naturally.

Various methods for cleaning by spraying dry ice made from carbon dioxide have previously been proposed. Spraying particles or pellets of ice previously formed using a firing machine is thus known. However, this method may prove to be too harsh for fragile surfaces.

Forming ice particles from carbon dioxide in the liquid state in contact with a working fluid which carries the particles as they are created and is also used for spraying same onto the surface to be cleaned is also known.

To implement the latter method, devices comprising a working fluid supply, a liquid carbon dioxide supply, a carbon dioxide ice formation chamber and a nozzle spraying, under the action of the working fluid, the particles formed in the chamber are known. Said nozzle comprises a convergent part, a throat and a divergent part. Such a device is described in the document EP-1 765 551.

In known devices, the nozzles exhibit a significant length for creating a stream of particles centred in the middle of the working fluid stream. This offers the advantage of particularly effective cleaning by concentrating the particle impact zone but involves drawbacks.

Firstly, these various devices are high consumers of working fluid. They are also difficult to handle. Furthermore, the carbon dioxide ice stream thereof has a limited impact area in respect of size.

### SUMMARY

The aim of the invention is that of solving all or some of the following problems and, for this purpose, relates to a device for spraying particles of dry ice, notably for the purpose of cleaning surfaces, comprising a spray nozzle, allowing the passage of a working fluid carrying said particles, said nozzle having an outlet orifice and comprising a throat and a divergent part, said divergent part extending between the throat and the outlet orifice of the nozzle.

According to the invention, said divergent part has at least one stage extending between the throat and the outlet orifice of said first stage, the ratio between the area of the throat and the area of said outlet orifice of the first stage of the divergent part being greater than 0.2, notably greater than 0.5, particularly greater than 0.73. Said ratio will be, for example less than 0.9.

Indeed, the applicant observed, following numerous tests, that such a nozzle was suitable for limiting the working fluid while obtaining very satisfactory cleaning results, notably in terms of removing greasy marks found on the objects to be cleaned. The invention will more generally be applicable for cleaning fine pollutions, less than 3 mm in thickness, among others. It further enables the use of nozzles of limited size, notably nozzles having divergent parts wherein the length between the throat and the outlet orifice of the nozzle is less than 50 mm.

To prevent any uncertainty, the term “cross-section” hereinafter refers to the cross-section of the nozzle along an orthogonal plane relative to the longitudinal extension direction thereof, i.e. the main direction along which the nozzle directs the fluid passing through said nozzle.

According to a first embodiment, said divergent part has a rectangular cross-section.

According to various aspects of this first embodiment, which may be considered together or separately:
the length I of said cross-section increases in a linear fashion at the or each of said stages of the divergent part extending from the throat to the outlet orifice of the nozzle,
said cross-section has a substantially constant width h at the or each of said stages of the divergent part, extending from the throat to the outlet orifice of the nozzle,
said cross-section has a substantially declining width h, at the or each of said stages of the divergent part, extending from the throat to the outlet orifice of the nozzle,
the outlet orifice of the nozzle is in the form of a slot having a width less than 1.5 mm and/or a length between 20 and 50 mm,
the throat has a rectangular cross-section.

According to a further embodiment of the invention, said divergent part has a circular cross-section. The throat may then have a circular cross-section.

To prevent any uncertainty, the term “divergence angle” will have the following meaning hereinafter. For nozzles wherein the divergent part has a rectangular cross-section wherein the length I increases in a linear fashion, it consists of the angle corresponding to the increasing slope of said length I for the or each stage of the divergent part. For nozzles wherein the divergent part has a round cross-section, it consists of the angle at the apex of the cone bearing the conical frustum forming the or each stage of the divergent part.

According to a first alternative embodiment, the divergent part of the device according to the invention has a single stage, said stage being provided with a divergence angle a in the region of 6°. Highly effective cleaning is thus obtained.

According to a second alternative embodiment, said divergent part has a single stage, said stage being provided with a divergence angle a greater than 7°, notably greater than 15°. A widened stream with an enlarged impact area is thus obtained.

In these various alternative embodiments, the length L of the divergent part measured between the throat and the outlet orifice of said stage, envisaged to merge with that of the nozzle, the length Iₛ of the cross-section of the divergent part at said outlet of the nozzle and the divergence angle α observe the following law:

(0.05×lₛ)/tan (α)≦L≦(0.4×Iₛ)/tan (α).

In a third alternative embodiment, the divergent part has a second stage, said first stage having a divergence angle in the region of 6° and the second stage a divergence angle greater than 7°, notably greater than 15°.

A particle acceleration effect, favourable for effective cleaning, is thus combined with a particle impact zone enlargement effect.

According to one aspect of the invention, said throat is a sonic throat. Moreover, the nozzle may have a convergent part provided upstream from the throat along the direction of working fluid circulation, charged with said particles, and wherein the convergent part and the divergent part are connected directly to each other at the throat.

It should also be noted that the invention relates to a device for spraying particles of dry ice, notably for the purpose of cleaning surfaces, comprising a spray nozzle, allowing the passage of a working fluid carrying said particles, said nozzle having an outlet orifice and comprising a throat, characterised in that the outlet orifice is at the throat.

Such a nozzle has lower cleaning performances than the previous nozzles but remains of interest in that it also enables a reduction in working fluid consumption.

The invention also relates to a nozzle of a spraying device as described above.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 schematically illustrates an example of a spraying device according to the invention,

FIG. 2a illustrates a front view of a first example of an embodiment of a nozzle of the device according to the invention,

FIG. 2b is a side view according to FIG. 2a,

FIG. 2c is a top view according to FIG. 2a,

FIG. 3a illustrates a side view of a second example of an embodiment of a nozzle of the device according to the invention,

FIG. 3b is a front view according to FIG. 3a,

FIG. 3c is a top view according to FIG. 3a,

FIG. 4a illustrates a front view of a third example of an embodiment of a nozzle of the device according to the invention,

FIG. 4b is a side view according to FIG. 4a,

FIG. 4c is a top view according to FIG. 4a.

### DESCRIPTION OF PREFERRED EMBODIMENTS

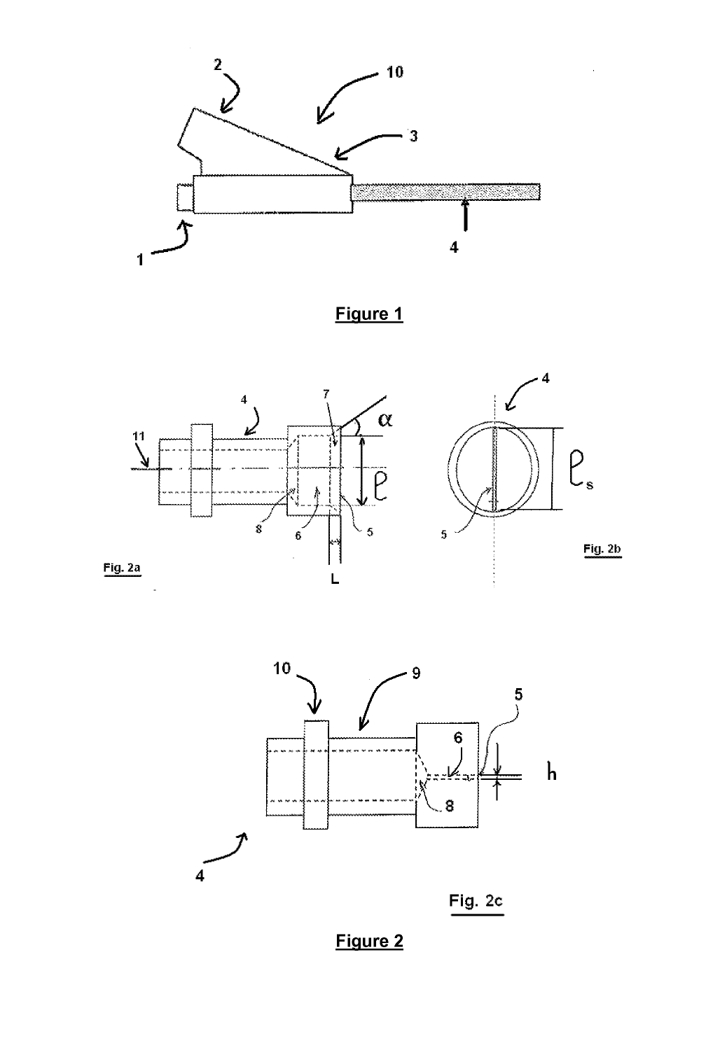

As illustrated in FIG. 1, the invention relates to a device for spraying particles of dry ice, for example dry ice made from carbon dioxide, notably for the purpose of cleaning surfaces.

Said device comprises a spray gun 10 equipped, notably, with a working fluid supply 1, a liquid carbon dioxide supply 2 and a carbon dioxide ice particle formation chamber 3. It also comprises a nozzle 4, connected to the spray gun 10, spraying, under the action of the working fluid, the particles formed in the chamber.

Said working fluid thus enters the device via the working fluid supply 1 and is charged with the particles of ice generated in the chamber 3, at the outflow from said chamber. In this way, a stream of working fluid and ice fluid is formed, which passes through the nozzle 4 to be sprayed onto the part to be cleaned. In other words, the nozzle 4 allows the passage of the working fluid, which carries said particles. Said working fluid is, for example, compressed air.

As illustrated in the following Figures, said nozzle 4 has an outlet orifice 5 and comprises a throat 6 and a divergent part 7. Said divergent part 7 extends between the throat 6 and the nozzle outlet orifice 5.

Said nozzle 4 further comprises in this case a convergent part 8, positioned upstream from the throat 6 in the direction of stream circulation. It may also have a connection 9 to the spray gun 10. Said connection 9 is optionally equipped with a securing ring 10, provided at a threaded portion of said connection 10.

Said nozzle has a longitudinal extension axis 11, i.e. an axis corresponding to the main direction of the stream passing therethrough.

Said divergent part 7 has at least one first stage extending between the throat 6 and an outlet orifice 5, 12 of said first stage, situated opposite the throat 6 in the direction of stream circulation. The throat 6 and said outlet 5, 12 of the first stage of the divergent part 7 are, for example, orthogonal in relation to the longitudinal extension axis 11 of the spray nozzle.

According to the invention, the ratio between the area of the throat 6 and the area of said outlet orifice 5, 12 of the first stage of the divergent part is greater than 0.2, notably greater than 0.5, particularly greater than 0.73. It will be, for example, less than 0.9. Indeed, the applicant observed that this parameter is critical in respect of the cleaning quality obtained and the working fluid consumption. It particularly enables suitable particle acceleration for reduced working fluid consumption. It may be, for example, between 0.8 and 0.9.

As illustrated, said divergent part 7 has, for example, a rectangular cross-section. The length I of said cross-section increases in a linear fashion at the or each of said stages of the divergent part 7 extending from the throat 6 to the outlet orifice 5 of the nozzle 4.

According to a first example of an embodiment, corresponding to FIGS. 2a to 2c, said divergent part 7 has a single stage and said cross-section has a substantially constant width h extending from the throat 6 to the outlet orifice 5 of the nozzle 4. It consists, notably, of a width h designed for the size of the particles formed. It is thus possible to use a width h less than 2 mm, for example in the region of 1.2 or 1.3 mm.

In this case, the throat 6 has a rectangular cross-section wherein one of the dimensions corresponds to the width h of the divergent part 7.

Furthermore, said divergent part has a divergence angle α greater than 7°, suitable for obtaining an enlargement of the stream at the nozzle outlet. In this case, it consists of an angle of approximately 45°. Alternatively, it may consist of an angle of approximately 6° suitable for retaining a substantially straight stream at the nozzle outlet.

More generally, said divergent part 7 may have a length L of said nozzle 4, measured between the throat 6 and the outlet orifice 5 of said nozzle 4, a length Iₛ of the cross-section of the divergent at said outlet 5 of the nozzle and a divergence angle α according to the following law:

(0.05×Iₛ)/tan (α)≦L≦(0.4×Iₛ)/tan (α).

In particular, L may have the following upper limit: (0.1×Iₛ)/tan (α).

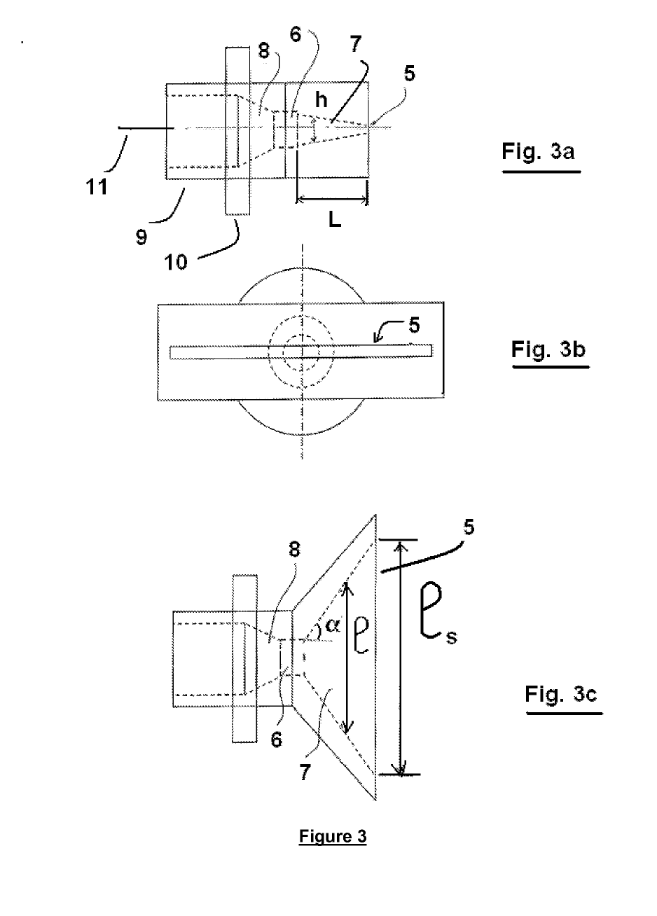

According to a second example of an embodiment, corresponding to FIGS. 3a to 3c, said divergent part 7 has a single stage and said cross-section has a substantially declining width h, notably in a linear fashion, extending from the throat 6 to the outlet orifice 5 of the nozzle 4.

In this case, the throat 6 has a rectangular cross-section wherein one of the dimensions corresponds to the width h of the divergent part 7 at the connection zone thereof with the throat 6.

Furthermore, said divergent part 7 has a divergence angle α greater than 7°, suitable for obtaining an enlargement of the stream at the nozzle outlet. In this case, it consists of an angle of approximately 70°.

In both cases described above, it is noted that the outlet orifice 5 of the nozzle is in the form of a slot. Said slot may have a height less than 2 mm, notably in the region of 1.2 or 1.3 mm and/or a length between 10 and 50 mm, notably between 20 and 50 mm.

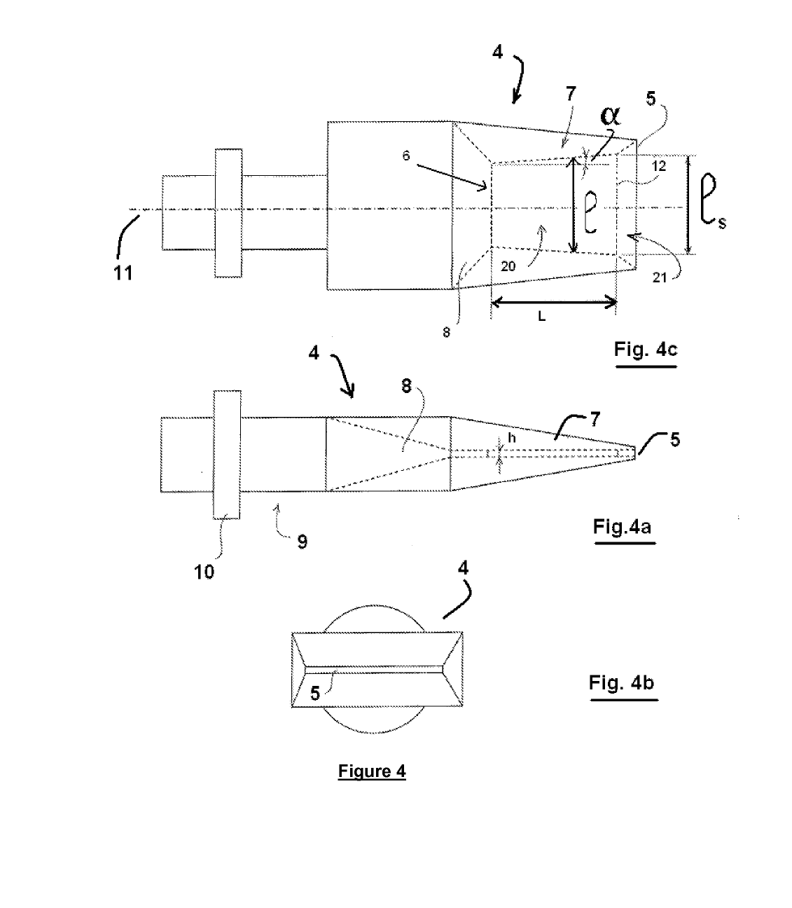

According to a third embodiment, corresponding to FIGS. 4a to 4c, said divergent part 7 has a first stage 20 and a second stage 21. Said first stage 20 has a divergence angle in the region of 6° and the second stage 21 a divergence angle greater than 7°, for example between 30 and 60° , in this case approximately 45°.

Without claiming to be a full explanation of the phenomena involved, the first stage 20 enables particle acceleration with a minimum working fluid consumption whereas the second enables an enlargement of the stream, while limiting working fluid overconsumption, the particles benefiting from the kinetic energy acquired in the first stage.

In this case, each of the stages has a rectangular cross-section, such as that of the embodiment in FIGS. 2, i.e. having a constant width h and a linearly increasing length I. The values of the width h may also be identical to that of the embodiment in FIGS. 2. They are identical from one stage to another.

In this case, the throat 6 has a rectangular cross-section wherein one of the dimensions corresponds to the width h of the first stage of the divergent part 7. The inlet orifice of the second stage of the divergent part 7 corresponds to the outlet orifice 12 of the first stage of said divergent part 7. The outlet orifice 5 of the nozzle may again be in the form of a slot. Said slot may have a height less than 2 mm, notably in the region of 1.2 or 1.3 mm and/or a length between 40 and 60 mm.

The formula given above also applies, at least for the first stage 20. In respect of the second stage 21, this stage will advantageously have a ratio between the area of the outlet orifice 5 thereof and the area of the inlet orifice thereof, corresponding to the outlet orifice 12 of the first stage 20, greater than 0.7. It will particularly be between 0.8 and 0.9.

According to a further embodiment, not shown, said divergent part has a circular cross-section. In other words, the divergent part has a truncated shape. Said throat may then have a circular cross-section. The divergence angle may be in the region of 6° or greater than 7°, with the same effects as those described above.

For example, the divergent parts 7 of the nozzles 4 according to the invention have a length, measured between the throat and the outlet orifice of the nozzle, less than 200 mm, notably 50 mm. Notably, it may consist of a length less than 10 mm for one-stage nozzles having a divergence angle greater than 7° or a length less than 40 mm to two-stage nozzles as described above.

That being so, said throat 6 is a sonic throat and, at the inlet of the nozzle 4, an absolute pressure is provided, for example, between 4 and 16 bar absolute, notably between 4 and 6 bar absolute.

As illustrated in FIGS. 4a to 4c, the convergent part 8 and divergent part 7 are connected directly to each other at the throat 6. In other words, the throat 6 is a single plane. Alternatively, as illustrated in FIGS. 2a to 2c and 3a to 3c, the throat 6 may have a non-zero length. Obviously, these various solutions are not connected to the particular embodiment wherein they are illustrated.

Furthermore, the convergent part 8 may have two stages, as in the embodiment in FIGS. 4a to 4c, where the cross-section thereof declines firstly in a first direction on a first portion 30 and then in another direction, orthogonal with respect to the first direction, in a second portion 31. In a further alternative embodiment, not shown, the nozzle does not comprise a divergent part. The outlet orifice thereof is thus situated at the throat thereof. The acceleration obtained will thus be limited to that offered by the sonic throat, which may however suffice and even be more favourable, particularly for cleaning lightly soiled and/or particularly fragile surfaces.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1-15. (canceled)

16. A device for spraying particles of dry ice for the purpose of cleaning surfaces, comprising a spray nozzle allowing the passage of a working fluid carrying the particles, the nozzle comprising an outlet orifice, a throat, and a divergent part, the divergent part extending between the throat and the nozzle outlet orifice, wherein the divergent part has at least one first stage extending between the throat and an outlet orifice of the first stage and the ratio between the area of the throat and the area of the outlet orifice of the first stage of the divergent part is greater than 0.2.

17. The device of claim 16 wherein the divergent part has a rectangular cross-section.

18. The device of claim 17, wherein the length of the cross-section increases in a linear fashion at the or each of the stages of the divergent part, extending from the throat to the outlet orifice of the nozzle.

19. The device of claim 17, wherein the cross-section has a substantially constant width h at the or each of the stages of the divergent part, extending from the throat to the outlet orifice of the nozzle.

20. The device of claim 17, wherein the cross-section has a substantially declining width h at the or each of the stages of the divergent part, extending from the throat to the outlet orifice of the nozzle.

21. The device of claim 16, wherein the throat has a rectangular cross-section.

22. The device of claims 16, wherein the divergent part has a circular cross-section.

23. The device of claim 16, wherein the throat has a circular cross-section.

24. The device of claim 16, wherein the divergent part has a single stage, the stage being provided with a divergence angle α in the region of 6°.

25. The device of claim 16, wherein the divergent part has a single stage, the stage being provided with a divergence angle α greater than 7°.

26. The device of claim 16, wherein the divergent part has a single stage and wherein the length L of the stage, measured between the throat and the outlet orifice of the stage, envisaged to merge with that of the nozzle, the length IS of the cross-section of the divergent part at the outlet of the nozzle and the divergence angle α at the neck observe the following law:
(0.05×IS)/tan (α)≦L≦(0.4×IS)/tan (α).

27. The device of claim 16, wherein the divergent part has a second stage, the first stage having a divergence angle in the region of 6° and the second stage a divergence angle greater than 7°.

28. A device for spraying particles of dry ice for the purpose of cleaning surfaces, comprising a spray nozzle allowing the passage of a working fluid carrying the particles, the nozzle having an outlet orifice and comprising a throat, wherein the outlet orifice is at the throat.

29. The device of claim 28, wherein the throat is a sonic throat.

30. The device of claim 28, wherein the nozzle has a convergent part, provided upstream from the throat along the direction of working fluid circulation, charged with the particles, and wherein the convergent part and the divergent part are directly connected to each other at the throat.
